(19) United States
(12) Patent Application Publication
(10) Pub. No.: US 2019/0259322 A1
(43) Pub. Date: Aug. 22, 2019

(54) DEVICE AND METHOD FOR DRIVING DISPLAY PANEL

(71) Applicant: Synaptics Incorporated, San Jose, CA (US)

(72) Inventor: Yutaka SAEKI, Tokyo (JP)

(21) Appl. No.: 16/280,159

(22) Filed: Feb. 20, 2019

(30) Foreign Application Priority Data
Feb. 22, 2018 (JP) 2018-029464
Feb. 18, 2019 (JP) 2019-026400

(51) Int. Cl. G09G 3/20

(52) U.S. Cl. CPC G09G 3/20; G09G 2300/0828; G09G 2310/0291; G09G 2310/027; G09G 2300/0426

(57) ABSTRACT

A display driver comprises a digital-to-analog converter (DAC) configured to output a grayscale voltage corresponding to an image data. The display driver further comprises a source amplifier configured to drive a source line of a display panel, and a buffer connected between the DAC and the source amplifier. The buffer comprises a first NMOS transistor having a gate supplied with the grayscale voltage and a drain connected to a power supply. The buffer is configured to supply a current depending on a first current flowing through the first NMOS transistor to an input terminal of the source amplifier.

### CROSS REFERENCE

This application claims priority to Japanese Patent Application No. 2018-029464, filed on Feb. 22, 2018, and Japanese Patent Application No. 2019-026400, filed on Feb. 18, 2019, the disclosures of which are incorporated herein by reference in their entirety.

### BACKGROUND

### Field

The present disclosure relates to a display driver and a display device.

### Description of the Related Art

A display driver configured to drive a display panel such as a liquid crystal display (LCD) panel or an organic light emitting diode (OLED) display panel may be configured to drive source lines, which may be also referred to as signal lines or data lines. A display driver is often designed to display images at a high refresh rate.

### SUMMARY

In one or more embodiments, a display driver comprises a digital-to-analog converter (DAC) configured to output a grayscale voltage corresponding to an image data; a source amplifier configured to drive a source line of a display panel, and a buffer connected between the DAC and the source amplifier. The buffer comprises an NMOS transistor having a gate supplied with the grayscale voltage and a drain connected to a power supply. The buffer is configured to supply to an input terminal of the source amplifier a current that depends on a current flowing through the NMOS transistor.

In one or more embodiments, a display device comprises a display panel comprising a source line and a display driver configured to drive the display panel. The display driver comprises a digital-to-analog converter (DAC) configured to output a grayscale voltage corresponding to an image data, a source amplifier configured to drive the source line of the display panel, and a buffer connected between the DAC and the source amplifier. The buffer comprises an NMOS transistor having a gate supplied with the grayscale voltage and a drain connected to a power supply. The buffer is configured to supply to an input terminal of the source amplifier a current that depends on a current flowing through the NMOS transistor.

In one or more embodiments, a method of driving a display panel comprises: outputting a grayscale voltage corresponding to an image data, supplying to an input terminal of a source amplifier a current that depends on a current flowing through an NMOS transistor having a gate supplied with the grayscale voltage and a drain connected to a power supply, and driving a source line of a display panel with the source amplifier.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only some embodiments of this disclosure and are therefore not to be considered limiting of its scope, for the disclosure may admit to other equally effective embodiments.

FIG. 1 is a block diagram illustrating an example configuration of a display device, according to one or more embodiments.

FIG. 2 is a circuit diagram illustrating an example configuration of a source driver circuitry, according to one or more embodiments.

FIG. 3 is a circuit diagram illustrating an example configuration of a source amplifier, according to one or more embodiments.

FIG. 4 is a circuitry diagram illustrating an example configuration of a buffer, according to one or more embodiments.

FIG. 5 is a timing chart illustrating an example operation of the buffer, according to one or more embodiments.

FIG. 6 is a circuit diagram illustrating an example configuration of a buffer, according to alternative embodiments.

FIG. 7 is a circuit diagram illustrating an example configuration of a buffer, according to alternative embodiments.

FIG. 8 is a circuit diagram illustrating an example configuration of a buffer, according to alternative embodiments.

### DETAILED DESCRIPTION

In the following, a description is given of embodiments of the present disclosure with reference to the attached drawings. In the attached drawings, same or similar components may be denoted by same or corresponding reference numerals. Suffixes may be attached to reference numerals to distinguish the same components from each other.

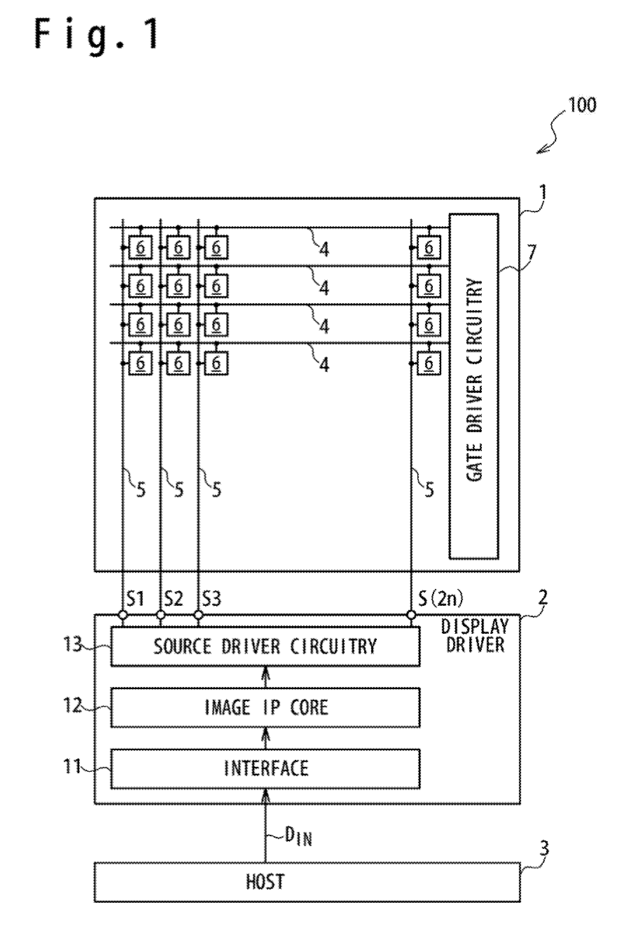

In one or more embodiments, as illustrated in FIG. 1, a display device 100 comprises a display panel 1 and a display driver 2. In one or more embodiments, the display device 100 is configured to display an image on the display panel 1 based on an image data D_{IN} received from a host 3.

In one or more embodiments, the display panel 1 comprises gate lines 4, source lines 5, pixel circuits 6, and gate driver circuitry 7. In one or more embodiments, each pixel circuit 6 is disposed at an intersection of a corresponding gate line 4 and source line 5, and used as a subpixel of a pixel of the display panel 1. When a liquid crystal display (LCD) panel is used as the display panel 1, each pixel circuit 6 may comprise a pixel electrode, a select transistor, and a storage capacitor. When an organic light emitting diode (OLED) display panel is used as the display panel 1, each pixel circuit 6 may comprise a light emitting element, a select transistor, and a storage capacitor. The display panel 1 may additionally comprise various lines other than the gate lines 4 and the source lines 5, depending on the configuration of the pixel circuits 6.

In one or more embodiments, the display driver 2 comprises source outputs S1 to S(2n) respectively connected to the source lines 5 of the display panel 1. In one or more embodiments, the display driver 2 is configured to drive the source lines 5 based on the image data D_{IN} received from the host 3. The display driver 2 may comprise an interface 11, an image IP core 12, and source driver circuitry 13. In one or more embodiments, the interface 11 is configured to transfer to the image IP core 12 the image data D_{IN} received from the host 3. In one or more embodiments, the image IP core 12 performs desired image processing on the image data D_{IN}. In one or more embodiments, the source driver circuitry 13 is configured to drive the source lines 5 of the display panel 1 based on an image data output from the image IP core 12.

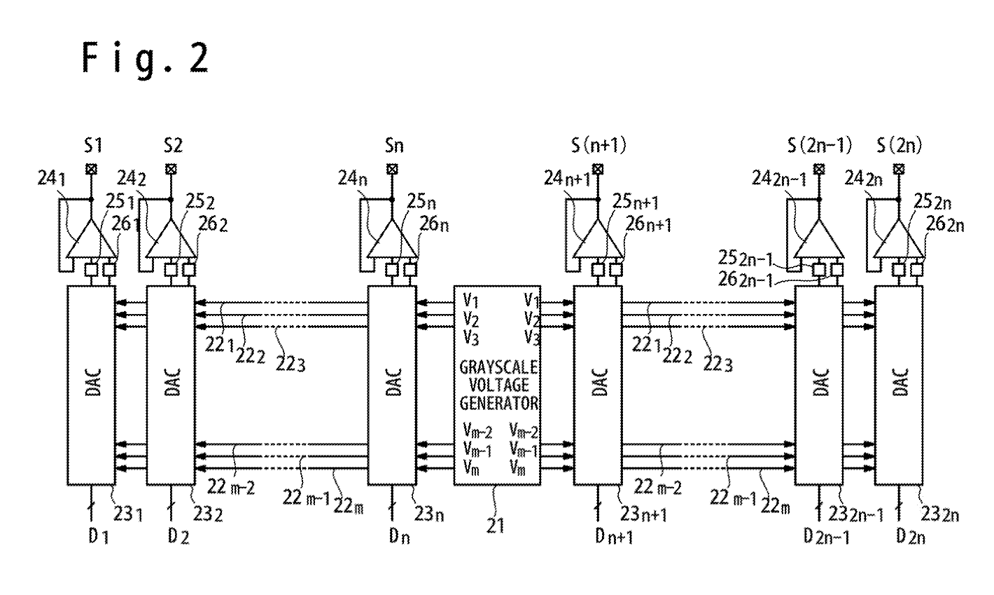

In one or more embodiments, as illustrated in FIG. 2, the source driver circuitry 13 comprises grayscale voltage generator circuitry 21, grayscale voltage lines 22₁ to 22ₘ, digital-to-analog converters (DACs) 23₁ to 23₂ₙ, and source amplifiers 24₁ to 24₂ₘ. In FIG. 2, the legends “D₁” to “D₂ₙ” denote image data associated with the source outputs S1 to S(2n), respectively.

In one or more embodiments, the grayscale voltage generator circuitry 21 is configured to generate grayscale voltages V₁ to Vₘ respectively associated with allowed grayscale values of the image data D₁ to D₂ₙ and supply the grayscale voltages V₁ to Vₘ to the DACs 23₁ to 23₂, via the grayscale voltage lines 22₁ to 22ₘ. In one or more embodiments, the grayscale voltages V₁ to Vₘ have different voltage levels from one another.

In one or more embodiments, the DACs 23₁ to 23₂ₙ are configured to select the grayscale voltages V₁ to Vₘ received via the grayscale voltage lines 22₁ to 22ₘ, based on the grayscale values described in the image data D₁ to D₂ₙ and output the selected grayscale voltages. In one or more embodiments, each DAC 23ᵢ is configured to operate as a selector that selects two of the grayscale voltage lines 22₁ to 22ₘ based on a grayscale value described in the image data Dᵢ and connects the selected two grayscale voltage lines 22 to an output terminal thereof. In one or more embodiments, each DAC 23ᵢ itself fails to have a driving ability.

The source amplifiers 24₁ to 24₂ₙ are configured to drive the source outputs S1 to S(2n) based on the grayscale voltages selected by the DACs 23₁ to 23₂ₙ. In one or more embodiments, each source amplifier 24ᵢ has two inputs and is configured to drive the source output Si based on the voltages supplied to the two inputs.

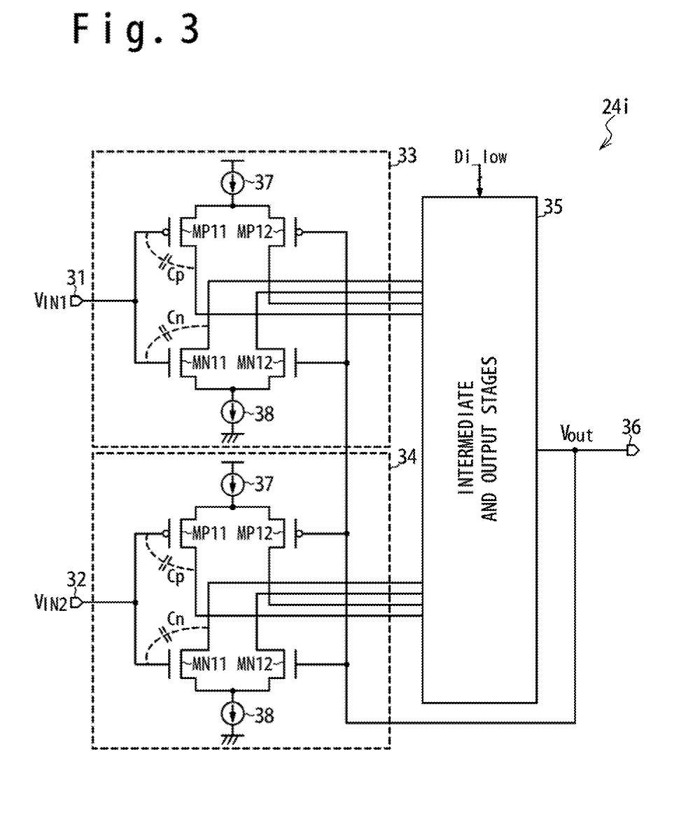

As illustrated in FIG. 3, in one or more embodiments, each source amplifier 24ᵢ may comprise two input terminals 31, 32, two input stages 33, 34, intermediate and output stages, and an output terminal 36. In FIG. 3, the intermediate and output stages are collectively denoted by the numeral 35.

In one or more embodiments, the input stage 33 comprises PMOS transistors MP11, MP12, NMOS transistors MN11, MN12, and constant current sources 37 and 38. In one or more embodiments, sources of the PMOS transistors MP11 and MP12 are commonly connected to the constant current source 37 and drains of the same are commonly connected to the intermediate stage. In one or more embodiments, the PMOS transistor MP11 has a gate connected to the input terminal 31, and the PMOS transistor MP12 has a gate connected to the output terminal 36. In one or more embodiments, the input stage 34 is configured similarly to the input stage 33 except for that the PMOS transistor MP11 and the NMOS transistor MN11 are connected to the input terminal 32.

In one or more embodiments, the intermediate and output stages 35 are configured to output an output voltage V_{OUT} based on lower bits D_{i_low} of the image data Dᵢ and input voltages V_{IN1} and V_{IN2} supplied to the input terminals 31 and 32, respectively. In one or more embodiments, the input voltage V_{IN2} supplied to the input terminal 32 may be higher than the input voltage V_{IN1} supplied to the input terminal 31, and the intermediate and output stages 35 may be configured to output the output voltage V_{OUT} based on the lower bits D_{i_low} of the image data Dᵢ so that the output voltage V_{OUT} ranges from the input voltage V_{IN1} to the input voltage V_{IN2}.

In one or more embodiments, the capacitance of the input terminal 31 of each source amplifier 24ᵢ is approximately the sum of the gate capacitances Cp and Cn of the PMOS transistor MP11 and NMOS transistors MN11 of the input stage 33, and the capacitance of the input terminal 32 is approximately the sum of the gate capacitances Cp and Cn of the PMOS transistor MP11 and NMOS transistor MN11 of the input stage 34. In one or more embodiments, as the gate capacitances Cp and Cn of the PMOS transistors MP11 and NMOS transistors MN11 are minimal, the capacitances of the input terminals 31 and 32 of each source amplifier 24ᵢ are considerably smaller than the capacitances of the grayscale voltage lines 22₁ to 22ₘ.

In one or more embodiments, the refresh rate of the display device 100 may be increased by reducing delays in the rising and falling input voltages of the source amplifiers 24₁ to 24₂ₙ. For example, in one or more embodiments, reducing the effective input capacitances of the source amplifiers 24₁ to 24₂ₙ reduces the delays in the rising and falling input voltages of the source amplifiers 24₁ to 24₂ₙ, which increases the refresh rate of the display device 100.

In one embodiment, the effective input capacitances of the source amplifiers 24₁ to 24₂ₙ are reduced by reducing influences of a Miller effect on the source amplifiers 24₁ to 24₂ₙ. The Miller effect may increase the effective input capacitance of each source amplifier 24₁ to 24₂ₙ to 1+A times the capacitance of a respective input terminal of each source amplifier 24₁ to 24₂ₙ, where A is the gain of each respective source amplifier 24₁ to 24₂ₙ.

In one or more embodiments, the source driver circuitry 13 is configured to achieve rapid rising and falling of the input voltages of the source amplifiers 24₁ to 24₂ₙ, increasing the refresh rate of the display device 100, by at least minimizing the Miller effect of each source amplifier 24₁ to 24₂ₙ. For example, minimizing the Miller effect of each source amplifier may reduce the effective input capacitance of the source amplifiers 24₁ to 24₂, and reduce delays in the rising and falling input voltages of the source amplifiers 24₁ to 24₂ₙ.

In one or more embodiments, to reduce the effective input capacitances of the source amplifiers 24₁ to 24₂ₙ viewed from the grayscale voltage lines 22₁ to 22ₘ, buffers 25₁ to 25₂ₙ and 26₁ to 26₂ₙ are inserted between the DACs 23₁ to 23₂ₙ and the source amplifiers 24₁ to 24₂ₙ.

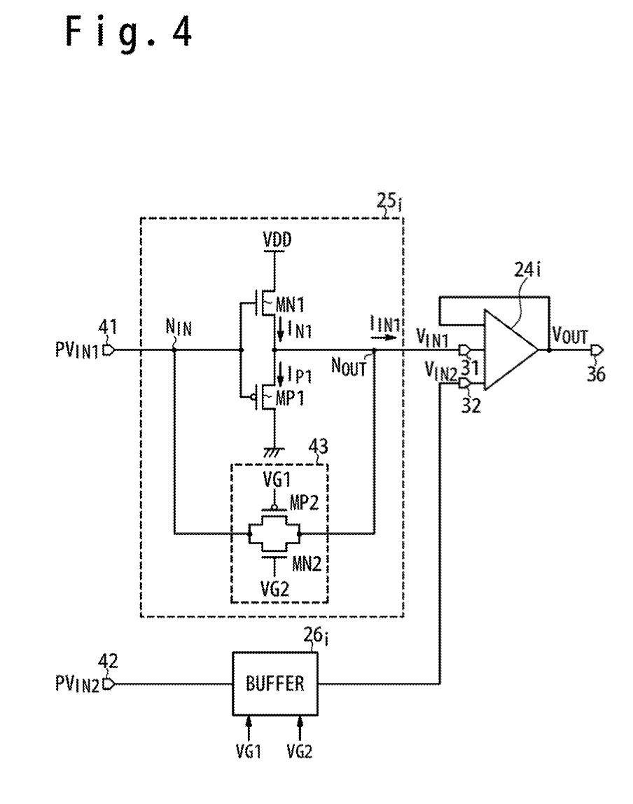

FIG. 4 is a circuit diagram illustrating one example configuration of the buffer 25ᵢ connected to the input terminal 31 of the source amplifier 24ᵢ, according to one or more embodiments. In FIG. 4, the numerals 41 and 42 denote two output terminals of the DAC 23ᵢ. In one or more embodiments, the DAC 23ᵢ is configured to connect two of the grayscale voltage lines 22₁ to 22ₘ to the output terminals 41 and 42, based on the grayscale value described in the image data Dᵢ. The buffer 25ᵢ has an input node N_{IN} connected to the output terminal 41 of the DAC 23ᵢ and an output node N_{OUT} connected to the input terminal 31 of the source amplifier 24ᵢ. The configuration and operation of the buffer 26ᵢ, which is connected to the input terminal 32 of the source amplifier 24ᵢ, are similar to those of the buffer 25ᵢ. The circuit configuration of the buffer 26ᵢ is not illustrated in FIG. 4.

In one or more embodiments, the buffer 25ᵢ comprises an NMOS transistor MN1, a PMOS transistor MP1, and a switch 43.

In one or more embodiments, the NMOS transistor MN1 and the PMOS transistor MP1 are each configured to drive the input terminal 31 of the source amplifier 24ᵢ through a source follower operation. In one or more embodiments, gates of the NMOS transistor MN1 and the PMOS transistor MP1 are commonly connected to the input node N_{IN} to receive a grayscale voltage PV_{IN1} from the output terminal 41 of the DAC 23ᵢ. In one or more embodiments, the NMOS transistor MN1 has a drain connected to a power supply configured to supply a power supply voltage VDD and a source connected to the output node N_{OUT}. In one or more embodiments, the PMOS transistor MP1 has a drain connected to a circuit ground and a source connected to the output node N_{OUT}. In one or more embodiments, the NMOS transistor MN1 operates as a pull-up transistor configured to pull up the input terminal 31 of the source amplifier 24ᵢ, and the PMOS transistor MP1 operates as a pull-down transistor configured to pull down the input terminal 31.

In one or more embodiments, a current I_{N1} is generated through the NMOS transistor MN1, based on the grayscale voltage PV_{IN1} supplied to the gate of the NMOS transistor MN1, and the NMOS transistor MN1 is configured to supply the current I_{N1} to the input terminal 31 of the source amplifier 24ᵢ. Similarly, in one or more embodiments, a current I_{P1} is generated through the PMOS transistor MP1, based on the grayscale voltage PV_{IN1} supplied to the gate of the PMOS transistor MP1, and the PMOS transistor MP1 is configured to draw the current I_{P1} from the input terminal 31 of the source amplifier 24ᵢ.

In one or more embodiments, the switch 43 comprises an NMOS transistor MN2 and a PMOS transistor MP2. In one or more embodiments, the NMOS transistor MN2 and the PMOS transistor MP2 form a transmission gate connected between the input node N_{IN} and the output node N_{OUT}. In one or more embodiments, the NMOS transistor MN2 has a drain connected to the input node N_{IN} and a source connected to the output node N_{OUT}. In one or more embodiments, the PMOS transistor MP2 has a source connected to the input node N_{IN} and a drain connected to the output node N_{OUT}. In one or more embodiments, a gate of the NMOS transistor MN2 is supplied with a control signal VG1 and a gate of the PMOS transistor MP2 is supplied with a control signal VG2. In one or more embodiments, the switch 43 is configured to electrically connect or disconnect the input node N_{IN} to or from the output node N_{OUT} under control of the control signals VG1 and VG2.

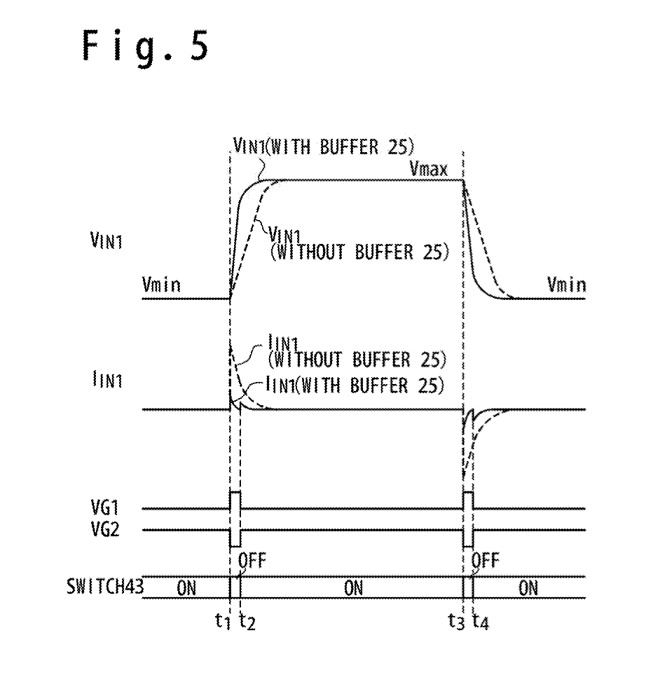

FIG. 5 illustrates one example operation of the buffer 25ᵢ, according to one or more embodiments. In one or more embodiments, at time t₀, the grayscale voltage PV_{IN1} is Vmin and the switch 43 is set to the ON state, where Vmin is the allowed lowest grayscale voltage. In the operation illustrated in FIG. 5, the input voltage V_{IN1} supplied to the input terminal 31 of the source amplifier 24ᵢ is Vmin at time t₀.

In one or more embodiments, the image data Dᵢ supplied to the DAC 23ᵢ changes at time t₁, and the grayscale voltage PV_{IN1} supplied from the DAC 23ᵢ to the buffer 25ᵢ also changes accordingly. FIG. 5 illustrates an example operation in which the grayscale voltage PV_{IN1} changes from Vmin to Vmax at time t₁, where Vmax is the allowed highest grayscale voltage, according to one or more embodiments.

In one or more embodiments, the switch 43 is set to the OFF state by the control signals VG1 and VG2 at time t₁ in synchronization with the change in the image data Dᵢ. In one or more embodiments, when the switch 43 is turned OFF, the NMOS transistor MN1 operates as a source follower to supply the current I_{N1} to the input terminal 31 of the source amplifier 24ᵢ. In one or more embodiments, this increases the voltage level on the input terminal 31. In one or more embodiments, when the threshold voltage of the NMOS transistor MN1 is V_{TH_N}, the NMOS transistor MN1 pulls up the input terminal 31 of the source amplifier 24ᵢ to Vmax−V_{TH_N}.

In one or more embodiments, this is followed by setting the switch 43 to the ON state by the control signals VG1 and VG2 at time t₂. When the switch 43 is turned ON, in one or more embodiments, the output terminal 41 of the DAC 23ᵢ is electrically connected to the input terminal 31 of the source amplifier 24ᵢ, and thereby the input terminal 31 of the source amplifier 24ᵢ is pulled up to Vmax.

In one or more embodiments, when the image data Dᵢ supplied to the DAC 23ᵢ then changes at time t₃, the grayscale voltage PV_{IN1} supplied from the DAC 23ᵢ to the buffer 25ᵢ also changes. FIG. 5 illustrates an operation in which the grayscale voltage PV_{IN1} changes from Vmax to Vmin at time t₃, according to one or more embodiments.

In one or more embodiments, the switch 43 is set to the OFF state by the control signals VG1 and VG2 at time t₃ in synchronization with the change in the image data Dᵢ. In one or more embodiments, when the switch 43 is turned OFF, the PMOS transistor MP1 operates as a source follower to draw the current I_{P1} from the input terminal 31 of the source amplifier 24ᵢ. In one or more embodiments, this decreases the voltage level on the input terminal 31. In one or more embodiments, when the threshold voltage of the PMOS transistor MP1 is −V_{TH_P}, the PMOS transistor MP1 pulls down the input terminal 31 of the source amplifier 24ᵢ to Vmin+V_{TH_P}.

In one or more embodiments, this is followed by setting the switch 43 to the ON state by the control signals VG1 and VG2 at time t₄. When the switch 43 is turned ON, in one or more embodiments, the output terminal 41 of the DAC 23ᵢ is electrically connected to the input terminal 31 of the source amplifier 24ᵢ, and thereby the input terminal 31 of the source amplifier 24ᵢ is pulled down to Vmin.

The output terminal 41 of the DA converter 23ᵢ may be directly connected to the input terminal 31 of the source amplifier 24ᵢ without providing the buffer 25ᵢ, increasing the effective input capacitance of the source amplifier 24ᵢ viewed from the DA converter 23ᵢ, which may significantly delay changes in the input voltage V_{IN1} supplied to the input terminal 31 of the source amplifier 24ᵢ from changes in the image data Dᵢ. In FIG. 5, the broken lines indicate example waveforms of the input voltage V_{IN1} and the input current I_{IN1} for the case when the output terminal 41 of the DAC 23ᵢ is directly connected to the input terminal 31 of the source amplifier 24ᵢ.

The circuit configuration illustrated in FIG. 5 effectively reduces the delays in rising and falling of the input voltage V_{IN1} supplied to the input terminal 31 of the source amplifier 24ᵢ through the effect of the buffer 25ᵢ. In one or more embodiments, when the buffer 25ᵢ is provided, Miller effect is significantly reduced since the buffer 25ᵢ does not have a voltage amplifying function. In one embodiment, when the buffer 25ᵢ is provided, no Miller effect occurs since the buffer 25ᵢ does not have a voltage amplifying function. This reduces the effective input capacitance of the buffer 25ᵢ viewed from the DAC 23ᵢ, and therefore the gate voltage of the NMOS transistor MN1 of the buffer 25ᵢ is rapidly driven to the grayscale voltage PV_{IN1} as desired. Although the NMOS transistor MN1 and the PMOS transistor MP1 do not drive the input terminal 31 of the source amplifier 24ᵢ to the grayscale voltage PV_{IN1}, the input terminal 31 of the source amplifier 24ᵢ can be driven to the grayscale voltage PV_{IN1} by turning on the switch 43. In one or more embodiments, the timing at which the switch 43 is turned ON is appropriately adjusted to drive the input voltage V_{IN1} supplied to the input terminal 31 of the source amplifier 24ᵢ to the grayscale voltage PV_{IN1}.

Similarly, the buffer 26ᵢ, which is configured similarly to the buffer 25ᵢ, reduces delays in rising and falling of the input voltage V_{IN2} supplied to the input terminal 32 of the source amplifier 24ᵢ.

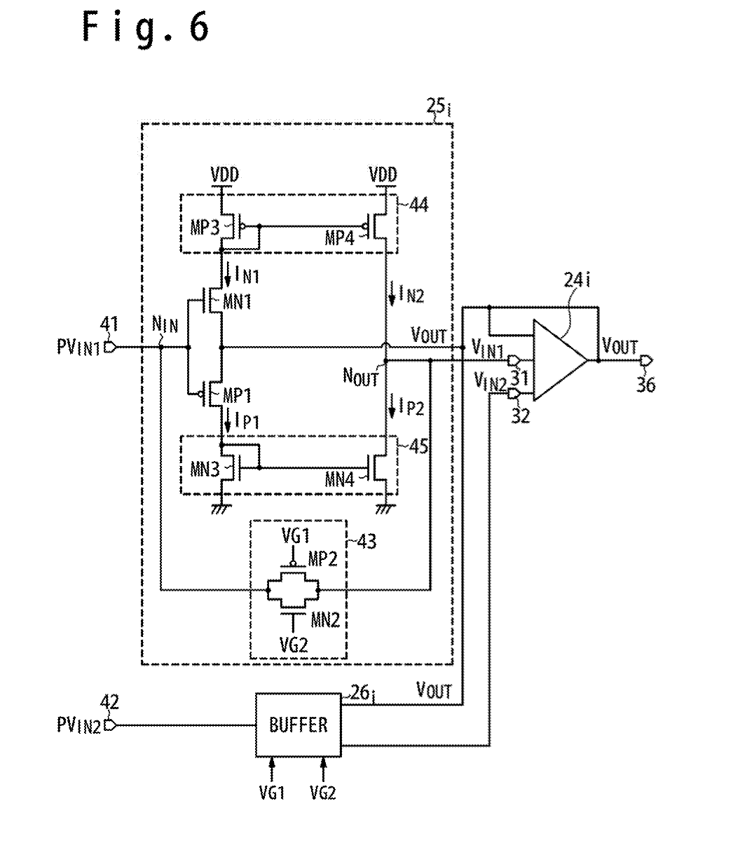

In one or more embodiments, as illustrated in FIG. 6, the buffer 25ᵢ comprises current mirrors 44 and 45 in addition to the NMOS transistor MN1, the PMOS transistor MP1, and the switch 43. In one or more embodiments, the source of the NMOS transistor MN1 and the drain of the PMOS transistor MP1 are commonly connected to the output terminal 36 of the source amplifier 24ᵢ.

In one or more embodiments, the current mirror 44 comprises PMOS transistors MP3 and MP4. In one or more embodiments, sources of the PMOS transistors MP3 and MP4 are commonly connected to the power supply and gates of the same are commonly connected to a drain of the PMOS transistor MP3. In one or more embodiments, the PMOS transistor MP3 has a drain connected to the drain of the NMOS transistor MN1 and the PMOS transistor MP4 has a drain connected to the output node Nₒᵤᵣ In one or more embodiments, the current mirror 44 is configured to supply to the input terminal 31 of the source amplifier 24ᵢ a current I_{N2} that depends on the current I_{N1} that flows through the NMOS transistor MN1. In one or more embodiments, the current I_{N2} is proportional to the current I_{N1}.

In one or more embodiments, the current mirror 45 comprises NMOS transistors MN3 and MN4. In one or more embodiments, sources of the NMOS transistors MN3 and MN4 are commonly connected to the circuit ground and gates of the same are commonly connected to a drain of the NMOS transistor MN3. In one or more embodiments, the NMOS transistor MN3 has a drain connected to the drain of the PMOS transistor MP1, and the NMOS transistor MN4 has a drain connected to the output node N_{OUT}. In one or more embodiments, the current mirror 45 is configured to draw from the input terminal 31 of the source amplifier 24ᵢ a current I_{P2} that depends on the current I_{P1} that flows through the PMOS transistor MP1. In one or more embodiments, the current I_{P2} is proportional to the current I_{P1}.

In one or more embodiments, the buffer 26ᵢ is configured similarly to the buffer 25ᵢ.

In one or more embodiments, the buffer 25ᵢ illustrated in FIG. 6 operates similarly to the buffer 25ᵢ illustrated in FIG. 4.

In one or more embodiments, the buffer 25ᵢ illustrated in FIG. 6 pulls up the input terminal 31 of the source amplifier 24ᵢ to a voltage level higher than PV_{IN1}−V_{TH_N}, where PV_{IN1} is the grayscale voltage supplied from the DAC 23ᵢ and V_{TH_N} is the threshold voltage of the NMOS transistor MN1. Due to a delay in the source amplifier 24ᵢ, the output voltage V_{OUT} of the source amplifier 24ᵢ remains unchanged for a while after a change in the image data Dᵢ supplied to the DAC 23ᵢ. Accordingly, the gate-source voltage of the NMOS transistor MN1 is sufficiently large for a while after the change in the image data Dᵢ, and the NMOS transistor MN1 is kept at the ON state. In one or more embodiments, the current mirror 44 continues to supply the current I_{N2} to the input terminal 31 of the source amplifier 24ᵢ, while the NMOS transistor MN1 is kept at the ON state, and this allows pulling up the voltage level on the input terminal 31 of the source amplifier 24ᵢ to a voltage level higher than PV_{IN1}−V_{TH_N}.

Through a similar process, the buffer 25ᵢ illustrated in FIG. 6 pulls down the input terminal 31 of the source amplifier 24ᵢ to a voltage level lower than PV_{IN1}+V_{TH_P} in one or more embodiments, where V_{TH_P} is the absolute value of the threshold voltage of the PMOS transistor MP1. As described above, the output voltage V_{OUT} of the source amplifier 24ᵢ remains unchanged for a while after a change in the image data Dᵢ supplied to the DAC 23ᵢ. Accordingly, the gate-source voltage of the PMOS transistor MP1 is sufficiently large for a while after the change in the image data Dᵢ, and the PMOS transistor MP1 is kept at the ON state. In one or more embodiments, the current mirror 45 continues to draw the current I_{P2} from the input terminal 31 of the source amplifier 24ᵢ, while the PMOS transistor MP1 is kept at the ON state, and this allows pulling down the voltage level on the input terminal 31 of the source amplifier 24ᵢ to a voltage level lower than PV_{IN1}+V_{TH_P}.

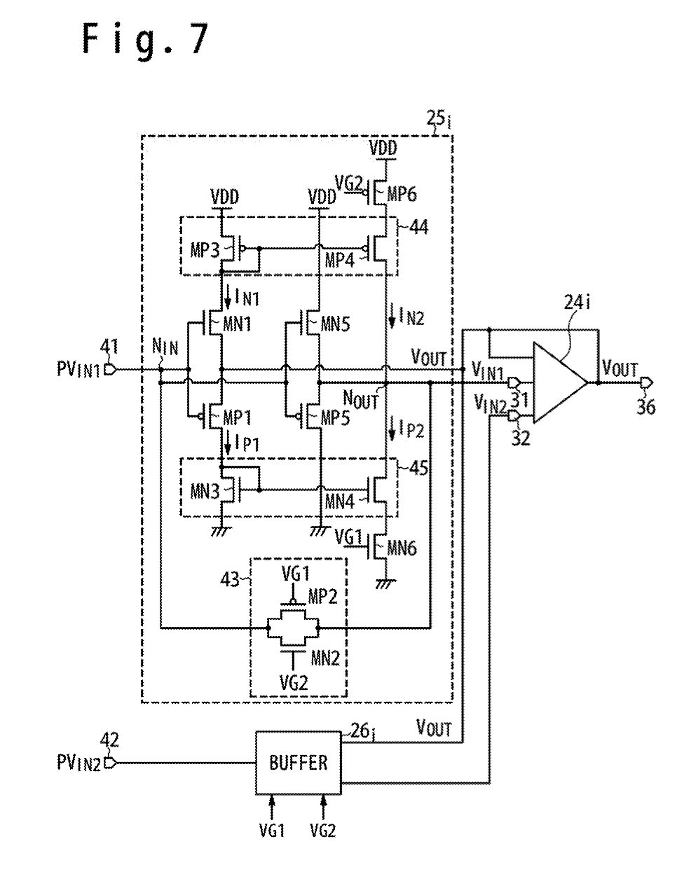

In one or more embodiments, as illustrated in FIG. 7, the buffer 25ᵢ is configured similarly to the configuration illustrated in FIG. 6, and further comprises NMOS transistors MN5, MN6 and PMOS transistors MP5 and MP6. In one or more embodiments, the buffer 26ᵢ is configured similarly to the buffer 25ᵢ.

In one or more embodiments, gates of the NMOS transistors MN5 and the PMOS transistor MP5 are commonly connected to the input node N_{IN} to receive the grayscale voltage PV_{IN1} from the output terminal 41 of the DAC 23ᵢ. In one or more embodiments, the NMOS transistor MN5 has a drain connected to the power supply that supplies the power supply voltage VDD and a source connected to the output node N_{OUT}. In one or more embodiments, the PMOS transistor MP5 has a drain connected to the circuit ground and a source connected to the output node N_{OUT}.

In one or more embodiments, the PMOS transistor MP6 is connected in series to the current mirror 44 between the power supply and the output node N_{OUT} and operates as a switch operating in response to the control signal VG2. In one or more embodiments, the PMOS transistor MP6 has a source connected to the power supply, a drain connected to the source of the PMOS transistor MP4 of the current mirror 44, and a gate supplied with the control signal VG2. Alternatively, the PMOS transistor MP6 may be connected between the current mirror 44 and the output node N_{OUT}.

The NMOS transistor MN6 is connected in series to the current mirror 45 between the circuit ground and the output node N_{OUT} and operates as a switch operating in response to the control signal VG1. In one or more embodiments, the NMOS transistor MN6 has a source connected to the circuit ground, a drain connected to the source of the NMOS transistor MN4 of the current mirror 45, and a gate supplied with the control signal VG1. Alternatively, the NMOS transistor MN6 may be connected between the current mirror 45 and the output node N_{OUT}.

The buffer 25ᵢ illustrated in FIG. 7, which operates in a similar way as the buffer 25ᵢ illustrated in FIG. 6, effectively suppresses an overshoot of the voltage level on the input terminal 31 of the source amplifier 24ᵢ through the operations of the NMOS transistor MN5 and the PMOS transistor MP5. In the configuration of the buffer 25ᵢ illustrated in FIG. 6, the current I_{N2} is continuously supplied from the current mirror 44 to the input terminal 31 of the source amplifier 24ᵢ during a pull-up of the input terminal 31 until the output terminal 36 of the source amplifier 24ᵢ is pulled up. This may cause an overshoot of the voltage level on the input terminal 31 of the source amplifier 24ᵢ. In the configuration of the buffer 25ᵢ illustrated in FIG. 7, the PMOS transistor MP5 is turned ON when the voltage level on the input terminal 31 of the source amplifier 24ᵢ is excessively increased. This effectively suppresses an overshoot of the voltage level on the input terminal 31. Similarly, the NMOS transistor MN5 is turned ON when the voltage level on the input terminal 31 of the source amplifier 24ᵢ is excessively decreased. This effectively suppresses an undershoot of the voltage level on the input terminal 31 of the source amplifier 24ᵢ.

Additionally, in the buffer 25ᵢ illustrated in FIG. 7, the PMOS transistor MP6 and the NMOS transistor MN6 are turned OFF to stop the operations of the current mirrors 44 and 45, when the switch 43 is turned ON in one or more embodiments. This operation effectively shortens the time during which a current flows from the power supply to the circuit ground through the current mirrors 44 and 45, effectively reducing the power consumption.

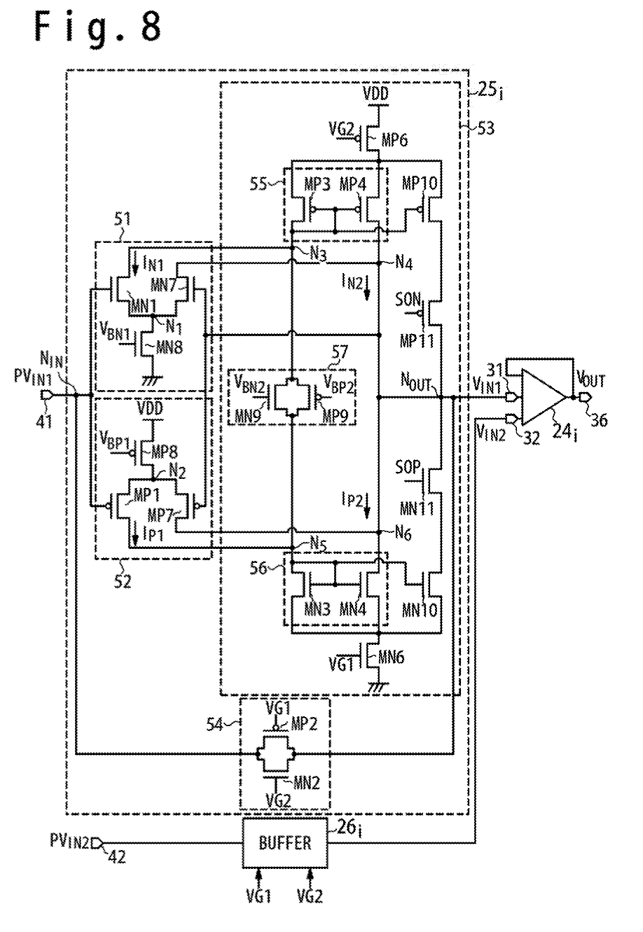

In one or more embodiments, as illustrated in FIG. 8, the buffer 25ᵢ is adapted to an “overdriving” operation. In one or more embodiments, the “overdriving” operation involves rapidly pulling up or down the output terminal 36 of the source amplifier 24ᵢ, when the output voltage V_{OUT} of the source amplifier 24ᵢ is to be largely changed.

In one or more embodiments, the buffer 25ᵢ is responsive to overdriving control signals SON and SOP for performing the overdriving operation. In one or more embodiments, the overdriving control signal SON is a low active signal and the overdriving control signal SOP is a high active signal. In one or more embodiments, the buffer 25ᵢ is configured to pull up the input terminal 31 of the source amplifier 24ᵢ to the power supply voltage VDD or a voltage close to the power supply voltage VDD, when the overdriving control signal SON is activated. This achieves rapidly pulling up the output terminal 36 of the source amplifier 24ᵢ. In one or more embodiments, the buffer 25ᵢ is configured to pull down the input terminal 31 of the source amplifier 24ᵢ to the circuit ground level or a voltage close to the circuit ground level, when the overdriving control signal SOP is activated. This achieves rapidly pulling down the output terminal 36 of the source amplifier 24ᵢ.

In one or more embodiments, the buffer 25ᵢ comprises an NMOS differential input stage 51, a PMOS differential input stage 52, active load circuitry 53, and a switch 54.

In one or more embodiments, the NMOS differential input stage 51 comprises NMOS transistors MN1, MN7, and MN8. In one or more embodiments, sources of the NMOS transistors MN1 and MN7 are commonly connected to a node N₁. In one or more embodiments, the NMOS transistor MN1 has a drain connected to a node N₃ of the active load circuitry 53, and the NMOS transistor MN7 has a drain connected to a node N₄ of the active load circuitry 53. In one or more embodiments, the NMOS transistor MN1 has a gate connected to the input node N_{IN} and the NMOS transistor MN7 has a gate connected to the output node N_{OUT}, which is connected to the input terminal 31 of the source amplifier 24ᵢ. In one or more embodiments, the NMOS transistor MN8 operates as a constant current source configured to draw a constant current from the node N₁. In one or more embodiments, the NMOS transistor MN8 has a drain connected to the node N₁, a source connected to the circuit ground, and a gate supplied with a bias voltage V_{BN1}.

The PMOS differential input stage 52 comprises PMOS transistors MP1, MP7, and MP8. In one or more embodiments, sources of the PMOS transistors MP1 and MP7 are commonly connected to a node N₂. In one or more embodiments, the PMOS transistor MP1 has a drain connected to a node N₅ of the active load circuitry 53, and the drain of the PMOS transistor MP7 has a drain connected to a node N₆ of the active load circuitry 53. In one or more embodiments, the PMOS transistor MP1 has a gate connected to the input node N_{IN} and the PMOS transistor MP7 has a gate connected to the output node N_{OUT}. In one or more embodiments, the PMOS transistor MP8 operates as a constant current source configured to supply a constant current to the node N₂. In one or more embodiments, the PMOS transistor MP8 has a drain connected to the node N₂, a source connected to the power supply, and a gate supplied with a bias voltage V_{BP1}.

In one or more embodiments, the active load circuitry 53 is connected to the drains of the NMOS transistor MN1 and the NMOS transistor MN7 and the drains of the PMOS transistor MP1 and the PMOS transistor MP7. In one or more embodiments, the active load circuitry 53 comprises current mirrors 55, 56, a floating constant current source 57, PMOS transistors MP6, MP10, MP11, and NMOS transistors MN6, MN10 and MN11.

In one or more embodiments, the PMOS transistor MP6 and the NMOS transistor MN6 are configured to enable the current mirrors 55 and 56 in response to the control signals VG1 and VG2, which are also used to control the switch 54. In one or more embodiments, the PMOS transistor MP6 has a source connected to the power supply and a drain connected to the current mirror 55. The PMOS transistor MP6 has a gate supplied with the control signal VG2. The NMOS transistor MN6 has a source connected to the circuit ground, a drain connected to the current mirror 56, and a gate supplied with the control signal VG1.

In one or more embodiments, the current mirror 55 is connected between the drain of the PMOS transistor MP6 and the nodes N₃ and N₄. In one or more embodiments, the current mirror 55 comprises PMOS transistors MP3 and MP4. In one or more embodiments, sources of the PMOS transistors MP3 and MP4 are commonly connected to the drain of the PMOS transistor MP6, and gates of the PMOS transistors MP3 and MP4 are commonly connected to a drain of the PMOS transistor MP3. In one or more embodiments, the drains of the PMOS transistors MP3 and MP4 are connected to the nodes N₃ and N₄, respectively.

In one or more embodiments, the current mirror 56 is connected between the drain of the NMOS transistor MN6 and the nodes N₅ and N₆. In one or more embodiments, the current mirror 56 comprises NMOS transistors MN3 and MN4. In one or more embodiments, sources of the NMOS transistors MN3 and MN4 are commonly connected to the drain of the NMOS transistor MN6, and gates of the NMOS transistors MN3 and MN4 are commonly connected to a drain of the NMOS transistor MN3. In one or more embodiments, the drains of the NMOS transistors MN3 and MN4 are connected to the nodes N₅ and N₆, respectively.

In one or more embodiments, the floating constant current source 57 is configured to draw a constant current from the node N₃, and supply the constant current to the node N₅. In one or more embodiments, the floating constant current source 57 comprises an NMOS transistor MN9 and a PMOS transistor MP9. In one or more embodiments, a drain of the NMOS transistor MN9 and a source of the PMOS transistor MP9 are commonly connected to the node N₃, and a source of the NMOS transistor MN9 and a drain of the PMOS transistor MP9 are commonly connected to the node N₅. A bias voltage V_{BN2} is supplied to a gate of the NMOS transistor MN9, and a bias voltage V_{BP2} is supplied to a gate of the PMOS transistor MP9.

In one or more embodiments, the switch 54 is connected between the input node N_{IN} and the output node N_{OUT}. In one or more embodiments, the switch 54 is configured to electrically connect and disconnect the input node N_{IN} and the output node N_{OUT} in response to the control signals VG1 and VG2. In one or more embodiments, the switch 54 comprises an NMOS transistor MN2 and a PMOS transistor MP2, which form a transmission gate. In one or more embodiments, the NMOS transistor MN2 has a drain connected to the input node N_{IN} and a source connected to the output node N_{OUT}. In one or more embodiments, the PMOS transistor MP2 has a source connected to the input node N_{IN} and a drain connected to the output node N_{OUT}. In one or more embodiments, the gate of the PMOS transistor MP2 is supplied with the control signal VG1 and the gate of the NMOS transistor MN2 is supplied with a control signal VG2.

In one or more embodiments, the PMOS transistors MP10, MP11 and the NMOS transistors MN10 and MN11 are used to achieve the overdriving operation in response to the overdriving control signals SON and SOP. In one or more embodiments, the PMOS transistors MP10 and MP11 are connected in series between the drain of the PMOS transistor MP6 and the output node N_{OUT}. In one or more embodiments, the PMOS transistor MP10 has a source connected to the drain of the PMOS transistor MP6 and a gate connected to the commonly connected gates of the PMOS transistors MP3 and MP4. In one or more embodiments, the PMOS transistor MP11 has a source connected to a drain of the PMOS transistor MP10 and a drain connected to the output node N_{OUT}. In one or more embodiments, the PMOS transistor MP11 has a gate supplied with the overdriving control signal SON. In one or more embodiments, the NMOS transistors MN10 and MN11 are connected in series between the drain of the NMOS transistor MN6 and the output node N_{OUT}. In one or more embodiments, the NMOS transistor MN10 has a source connected to the drain of the NMOS transistor MN6 and a gate connected to the commonly connected gates of the NMOS transistors MN3 and MN4. In one or more embodiments, the NMOS transistor MN11 has a source connected to a drain of the NMOS transistor MN10, a drain connected to the output node N_{OUT}, and a gate supplied with the overdriving control signal SOP.

In one or more embodiments, the buffer 25ᵢ illustrated in FIG. 8 is configured to drive the input terminal 31 of the source amplifier 24ᵢ through a source follower operation, when both of the overdriving control signals SON and SOP are deactivated.

In one or more embodiments, when the grayscale voltage PV_{IN1} is pulled up, a current I_{N1} is generated through the NMOS transistor MN1, depending on the grayscale voltage PV_{IN1} supplied to the gate of the NMOS transistor MN1, and the current mirror 55 supplies the current I_{N2} depending on the current I_{N1} to the input terminal 31 of the source amplifier 24ᵢ to increase the input voltage V_{IN1}. In one or more embodiments, this is followed by setting the switch 54 to the ON state by the control signals VG1 and VG2. When the switch 54 is turned ON, in one or more embodiments, the output terminal 41 of the DAC 23ᵢ is electrically connected to the input terminal 31 of the source amplifier 24ᵢ, and thereby the input terminal 31 of the source amplifier 24ᵢ is pulled up to the grayscale voltage PV_{IN1}.

In one or more embodiments, when the grayscale voltage PV_{IN1} is pulled down, a current I_{P1} is generated through the PMOS transistor MP1, depending on the grayscale voltage PV_{IN1} supplied to the gate of the PMOS transistor MP1, and the current mirror 56 draws a current I_{P2} that depends on the current I_{P1} from the input terminal 31 of the source amplifier 24ᵢ to decrease the input voltage V_{IN1}. In one or more embodiments, this is followed by setting the switch 54 to the ON state by the control signals VG1 and VG2. When the switch 54 is turned ON, in one or more embodiments, the output terminal 41 of the DAC 23ᵢ is electrically connected to the input terminal 31 of the source amplifier 24ᵢ, and thereby the input terminal 31 of the source amplifier 24ᵢ is pulled down to the grayscale voltage PV_{IN1}.

Use of the NMOS and PMOS differential input stages 51 and 52 as illustrated in FIG. 8 effectively reduces or eliminates the dead band in which none of the NMOS transistor MN1 and the PMOS transistor MP1 operates as a source follower. In one or more embodiments, at least one of the NMOS transistor MN1 and the PMOS transistor MP1 operates as a source follower to control the current I_{N2} and/or the current I_{P2} for the full allowed range of the grayscale voltage PV_{IN1}.

In one or more embodiments, when one of the overdriving control signals SON and SOP is activated, the buffer 25ᵢ operates to achieve the overdriving operation. In one or more embodiments, when the overdriving control signal SON is activated, the PMOS transistor MP11 is turned ON. In one or more embodiments, this achieves driving the input terminal 31 of the source amplifier 24ᵢ to the power supply voltage VDD or a voltage close to the power supply voltage VDD, independently of the grayscale voltage PV_{IN1}. In one or more embodiments, when the overdriving control signal SOP is activated, the NMOS transistor MN11 is turned ON. In one or more embodiments, this achieves driving the input terminal 31 of the source amplifier 24ᵢ to the circuit ground level or a voltage close to the circuit ground level, independently of the grayscale voltage PV_{IN1}.

Although various embodiments of this disclosure have been specifically described in the above, a person skilled in the art would appreciate that the technologies disclosed in this disclosure may be implemented with various modifications. For example, although the above-described embodiments recite the configuration in which each source amplifier 24ᵢ comprises two input terminals 31 and 32, the number of the input terminals of each source amplifier 24i is not limited to two. Each source amplifier 24ᵢ may comprise a single input terminal, or three or more input terminals. In this case, a buffer configured in the same configuration as the above-described buffer 25ᵢ is connect to each input terminal of the source amplifier 24ᵢ.

What is claimed is:

1. A display driver, comprising:
a digital-to-analog converter (DAC) configured to output a grayscale voltage corresponding to image data;
a source amplifier configured to drive a source line of a display panel; and
a buffer connected between the DAC and the source amplifier,
wherein the buffer comprises a first NMOS transistor having a gate supplied with the grayscale voltage and a drain connected to a power supply, and
wherein the buffer is configured to supply a current corresponding to a first current flowing through the first NMOS transistor to an input terminal of the source amplifier.

2. The display driver according to claim 1, wherein the buffer further comprises a first switch connected between an output terminal of the DAC and the input terminal of the source amplifier.

3. The display driver according to claim 1, wherein an output terminal of the source amplifier is connected to a source of the first NMOS transistor, and
wherein the buffer further comprises a current mirror configured to:
generate a third current corresponding to the first current; and
supply the third current to the input terminal of the source amplifier.

4. The display driver according to claim 3, wherein the buffer further comprises a first switch connected between an output terminal of the DAC and the input terminal of the source amplifier.

5. The display driver according to claim 1, wherein the buffer further comprises a first PMOS transistor having a gate supplied with the grayscale voltage and a drain connected to a circuit ground, and
wherein the buffer is configured to draw a first current corresponding to a second current flowing through the first PMOS transistor from the input terminal of the source amplifier.

6. The display driver according to claim 5, wherein a source of the first NMOS transistor and a source of the first PMOS transistor are commonly connected to an output terminal of the source amplifier, and
wherein the buffer further comprises:
a first current mirror configured to supply a third current corresponding to the first current to the input terminal of the source amplifier; and
a second current mirror configured to draw a fourth current corresponding to the second current from the input terminal of the source amplifier.

7. The display driver according to claim 6, wherein the buffer further comprises:
a second NMOS transistor comprising:
a gate supplied with the grayscale voltage;
a drain connected to the power supply; and
a source connected to the input terminal of the source amplifier; and
a second PMOS transistor comprising:
a gate supplied with the grayscale voltage;
a drain connected to the circuit ground; and
a source connected to the input terminal of the source amplifier.

8. The display driver according to claim 6, wherein the buffer further comprises a second switch connected in series to the first current mirror between the power supply and the input terminal of the source amplifier.

9. The display driver according to claim 6, wherein the buffer further comprises:
a second switch connected in series to the first current mirror between the power supply and the input terminal of the source amplifier; and
a third switch connected in series to the second current mirror between the circuit ground and the input terminal of the source amplifier.

10. The display driver according to claim 9, wherein the buffer further comprises a first switch connected between an output terminal of the DAC and the input terminal of the source amplifier, and wherein the second switch and the third switch are turned off when the first switch is turned on.

11. The display driver according to claim 9, wherein the buffer further comprises:
a second NMOS transistor comprising:
a gate supplied with the grayscale voltage;
a drain connected to the power supply; and
a source connected to the input terminal of the source amplifier; and
a second PMOS transistor comprising:
a gate supplied with the grayscale voltage;
a drain connected to the circuit ground; and
a source connected to the input terminal of the source amplifier.

12. The display driver according to claim 5, wherein the buffer further comprises:
a third NMOS transistor comprising:
a source connected to a source of the first NMOS transistor; and
a gate connected to the input terminal of the source amplifier; and
a third PMOS transistor comprising:
a source connected to a source of the first PMOS transistor; and
a gate connected to the input terminal of the source amplifier.

13. The display driver according to claim 12, wherein the buffer further comprises:
a first constant current source configured to draw a first constant current from the sources of the first NMOS transistor and the third NMOS transistor; and
a second constant current source configured to supply a second constant current to the sources of the first PMOS transistor and the third PMOS transistor.

14. The display driver according to claim 12, wherein the buffer further comprises active load circuitry connected to drains of the first NMOS transistor and the third NMOS transistor and drains of the first PMOS transistor and the third PMOS transistor, and
wherein the active load circuitry is configured to:
supply a third current corresponding to the first current to the input terminal of the source amplifier; and
draw a fourth current corresponding to the second current from the input terminal of the source amplifier.

15. The display driver according to claim 1, wherein the buffer further comprises:
a first switch connected between a power supply and the input terminal of the source amplifier and configured to operate in response to a first overdriving control signal; and
a second switch connected between a circuit ground and the input terminal of the source amplifier and configured to operate in response to a second overdriving control signal.

16. The display driver according to claim 1, further comprising:
grayscale voltage generator circuitry configured to generate a plurality of grayscale voltages on a plurality of grayscale voltage lines, respectively,
wherein the DAC is further configured to:
select at least one of the plurality of the grayscale voltage lines based on the image data; and
connect the at least one of the plurality of the grayscale voltage lines to the buffer.

17. A display device, comprising:
a display panel comprising a source line; and
a display driver comprising:
a digital-to-analog converter (DAC) configured to output a grayscale voltage corresponding to an image data;
a source amplifier configured to drive the source line; and
a buffer connected between the DAC and the source amplifier,
wherein the buffer comprises a first NMOS transistor having a gate supplied with the grayscale voltage and a drain connected to a power supply, and
wherein the buffer is configured to supply a current corresponding to a first current flowing through the first NMOS transistor to an input terminal of the source amplifier.

18. The display device according to claim 17, wherein the buffer further comprises a first PMOS transistor comprising:
a gate supplied with the grayscale voltage; and
a drain connected to a circuit ground, and
wherein the buffer is further configured to draw a current depending on a second current flowing through the first PMOS transistor from the input terminal of the source amplifier.

19. The display device according to claim 17, wherein the buffer further comprises a first switch connected between an output terminal of the DAC and the input terminal of the source amplifier.

20. A method of driving a display panel, comprising:
outputting a grayscale voltage corresponding to an image data;
supplying, to an input terminal of a source amplifier, a current corresponding to a first current flowing through an NMOS transistor which has a gate supplied with the grayscale voltage and a drain connected to a power supply; and
driving a source line of the display panel with the source amplifier.

21. The method according to claim 20, further comprising:
drawing from the input terminal of the source amplifier a current corresponding to a second current flowing through a PMOS transistor which has a gate supplied with the grayscale voltage and a drain connected to a circuit ground.

22. The method according to claim 20, further comprising:
electrically connecting an output terminal of a digital-to-analog converter (DAC) configured to output the grayscale voltage and an input terminal of the source amplifier.
